(19) United States
(12) Patent Application Publication
(10) Pub. No.: US 2024/0185082 A1
(43) Pub. Date: Jun. 6, 2024

(54) IMITATION LEARNING BASED ON PREDICTION OF OUTCOMES

(71) Applicant: DeepMind Technologies Limited, London (GB)

(72) Inventors: Andrew Coulter Jaegle, London (GB); Yury Sulsky, London (GB); Gregory Duncan Wayne, London (GB); Robert David Fergus, New York, NY (US)

(21) Appl. No.: 18/275,722

(22) PCT Filed: Feb. 4, 2022
(86) PCT No.: PCT/EP2022/052792

§ 371 Date: Aug. 3, 2023

Related U.S. Application Data
(60) Provisional application No. 63/146,370, filed on Feb. 5, 2021.

(51) Int. Cl. G06N 3/092

(52) U.S. Cl. CPC G06N 3/092

(57) ABSTRACT

A method is proposed of training a policy model to generate action data for controlling an agent to perform a task in an environment. The method comprises: obtaining, for each of a plurality of performances of the task, a corresponding demonstrator trajectory comprising a plurality of sets of state data characterizing the environment at each of a plurality of corresponding successive time steps during the performance of the task; using the demonstrator trajectories to generate a demonstrator model, the demonstrator model being operative to generate, for any said demonstrator trajectory, a value indicative of the probability of the demonstrator trajectory occurring; and jointly training an imitator model and a policy model. The joint training is performed by: generating a plurality of imitation trajectories, each imitation trajectory being generated by repeatedly receiving state data indicating a state of the environment, using the policy model to generate action data indicative of an action, and causing the action to be performed by the agent; training the imitator model using the imitation trajectories, the imitator model being operative to generate, for any said imitation trajectory, a value indicative of the probability of the imitation trajectory occurring; and training the policy model using a reward function which is a measure of the similarity of the demonstrator model and the imitator model.

### BACKGROUND

This specification relates to methods and systems for training a neural network to control an agent to carry out a task in an environment.

The training is in the context of an imitation learning system, in which a neural network is trained to control an agent to perform a task using data characterizing instances in which the task has previously been performed by a demonstrator, such as a human expert. The imitation learning system is a system that, at each of a series of successive time steps, selects an action to be performed by an agent interacting with an environment. In order for the agent to interact with the environment, the system receives data characterizing the current state of the environment and selects an action to be performed by the agent in response to the received data. Data characterizing a state of the environment is referred to in this specification as an observation, or as “state data”.

Neural networks are adaptive systems (machine learning models) that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes how a system implemented as computer programs in one or more computers in one or more locations can perform a method to train (that is, repeatedly adjust numerical parameters of) an adaptive system (“policy model”) which is part of a control system configured select actions to be performed by an agent interacting with an environment, based on state data characterizing (describing) the environment. The control system is operative to create control data (“action data”) which is transmitted to the agent to control it. The policy model may be deterministic (i.e. the action data is a uniquely determined by the input to the policy model); alternatively, the policy model may generate a probability distribution over possible realizations of the action data, and the control system may output action data which is selected from among the possible realizations of the action data according to the probability distribution.

The environment may be a real-world environment, and the agent may be an agent which operates on the real-world environment. For example, the agent may be a mechanical or electromechanical system (e.g., a robot) comprising one or more members connected together using joints which permit relative motion of the members, and one or more drive mechanisms which, according to the action data, control the relative position of the members or which are operative to move the robot through the environment.

Alternatively, the environment may be simulated environment and the agent may be a simulated agent moving within the environment. The simulated agent may have a simulated motion within the simulated environment which mimics the motion of the robot in the real environment. Thus the term “agent” is used to describe both a real agent (robot) and a simulated agent, and the term “environment” is used to describe both environments.

In the case that the environment is a real world environment, the policy model may make use of state data collected by one or more sensors and describing the real-world environment. For example the (or each) sensor may be a camera configured to collect images (still images or video images) of the real-world environment (which may include an image of at least a part of the agent). The sensor may further collect proprioceptive data describing the configuration of the agent. For example, the proprioceptive features may be positions and/or velocities of the members of the agent.

In general terms, the specification proposes that an adaptive policy model for generating action data for controlling an agent which operates on an environment, is iteratively trained based on demonstrator trajectories which are composed of sets of state data relating to successive time steps during a period (an “episode”) when a task was performed by a demonstrator (e.g. a human operator). During the training procedure the policy network is used to generate action data which controls the agent, to generate “imitation trajectories”, composed of sets of state data at successive time steps. The policy model is trained based on a policy model reward function (here just referred to as the “reward function”) which characterizes how similar the probability distribution of the demonstrator trajectories is to the probability distribution of the imitation trajectories.

The probability distribution of the demonstrator trajectories may be estimated using an adaptive system referred to as a demonstrator model. The demonstrator model is operative to generate, for any said demonstrator trajectory, a value indicative of the probability of the demonstrator trajectory occurring (e.g. given an initial state of the environment). For example, the demonstrator model may be operative to generate a value indicative of the probability of each set of state data of an demonstrator trajectory being generated (except the first set of state data of the demonstrator trajectory, which depends upon how the environment is initialized); the probability of the entire demonstrator trajectory being generated, given the initial state of the environment, may be generated by the demonstrator model as the product of these probabilities.

For each demonstrator trajectory, and for each time step in that demonstrator trajectory (except the first time step, corresponding to the first set of state data in the demonstrator trajectory, i.e. the state data for the initial state of the environment), the demonstrator model may be arranged to output a value indicative of the conditional probability of the corresponding state data, given the sets of state data at one or more preceding time steps in the demonstrator trajectory, e.g. only the set of state data for the immediately preceding time step.

The demonstrator model can be used to generate a value indicative of the probability of a trajectory occurring (one of the demonstrator trajectories or one of the imitation trajectories) as the product of the respective conditional probabilities of the sets of state data of the trajectory occurring (except the first set of state data, corresponding to the initial state).

Note that the demonstrator model does not receive any action data relating to the preceding time step. That is, the demonstrator model is a function of the state data at the preceding time step, but not action data at the preceding time step. Preferably the demonstrator model does not receive any action data; it is not conditioned on action data at all.

Training the demonstrator model can be performed using the demonstrator trajectories. Note that since the demonstrator model does not receive action data, the demonstrator model can be generated even when no action data is available. For example, the demonstrator trajectories may describe respective periods (“episodes”) when a task is performed by a human.

Similarly, the probability distribution of the imitation trajectories may be estimated using an adaptive system referred to as an imitator model. The imitator model is operative to generate, for any said imitation trajectory, a value indicative of the probability of the imitation trajectory occurring (e.g. given an initial state of the environment). The imitator model may be operative to generate a value indicative of the probability of each set of state data of an imitation trajectory being generated (except the first set of state data of the imitation trajectory, which depends upon how the environment is initialized); thus, the probability of the entire imitation trajectory being generated, given the initial state of the environment, is the product of these probabilities.

For each imitation trajectory, and for each time step in that imitation trajectory (except the first time step, corresponding to the first set of state data in the imitation trajectory, i.e. the state data for the initial state of the environment), the imitator model may be arranged to output a value indicative of the conditional probability of the corresponding state data, given the sets of state data at one or more preceding time steps in the imitation trajectory, e.g. only the set of state data for the immediately preceding time step.

The imitator model can be used to generate a value indicative of the probability of a trajectory occurring (e.g. one of the imitation trajectories) as the product of the respective conditional probabilities of the sets of state data of the trajectory (except the first set of state data, corresponding to the initial state).

Note that the imitator model, like the demonstrator model, does not receive any action data relating to the preceding time step. That is, the imitator model is a function of the state data at the preceding time step, but not action data at the preceding time step. Indeed, preferably the imitator model does not receive action data relating to any preceding time step; it is not conditioned on action data at all. The reward function may be defined based on comparing the respective probabilities of imitation trajectories under the demonstrator model and under the imitator model. Accordingly, the reward function for training the policy model is generated only using state data from the demonstrator trajectories and the imitation trajectories, and not using action data from those trajectories. Thus, any action data generated during the generation of each imitation trajectory may not be employed after the corresponding period, and may be discarded (deleted) after it has been used by the agent, e.g. after the imitation trajectory is completed and before any training using the imitation trajectory is performed.

The imitator model and demonstrator models are referred to as “effect models”. This term is used to mean that they are not conditioned on (do not receive as an input) data encoding actions performed by the agent in the demonstrator trajectories or the imitation trajectories. Furthermore they do not output data encoding actions. Instead, the only data they receive (input) encodes state date (i.e. observations) for one or more of the time-steps, and the data they output encodes a probability of the state data for the last one of those time-step being received given the state data for the other received time step(s).

If the probabilities are expressed in the logarithmic domain (i.e. the considering the logarithm of the probability of a given trajectory being generated), the logarithm of the probability of a trajectory may be separable into a sum of terms which each represent the logarithm of the conditional probability of a corresponding item of state data at a corresponding time step of the trajectory being generated, given the state data at one or more earlier time steps in the trajectory (typically, there is a respective term for every item of state data in the trajectory, except the state data of the initial state of the environment).

The effect models and/or the policy model may be implemented using neural networks such as feedforward networks, e.g. multi-layer perceptrons (MLP). In the case of the effect models, a neural network for each model may be trained to generate a value indicative of the conditional probability of an item of state data being generated in a trajectory, upon receiving data encoding the state data from the one or more preceding time step(s) of the same trajectory. The term can then be averaged over multiple trajectories.

The policy model may be trained to output data which characterizes a specific action (e.g. a one-hot vector which indicates that action) and which is used by the control system to generate control data for the agent, or probabilistic data which characterizes a distribution over possible actions. In the latter case, the control system generates the control data for the agent by selecting an action from the distribution.

The training of the models preferably includes regularization. The regularization may be performed for example by weight decay, using the network output at a time step as the input to the next, or by predicting multiple time steps at each step. The effect models are generative models, but their training is performed without an adversary network as in a generative-adversarial network (GAN) system.

Conveniently, the demonstrator model is trained before the joint training of the imitator model and the policy model, and remains unchanged during the joint training of the imitator model and the policy model. The demonstrator model may be trained by an iterative process. In each iteration, it may be modified so as to increase the value of a demonstrator reward function which characterizes the probability of a plurality of the demonstrator trajectories (e.g. a subset of all the demonstrator trajectories) occurring according to the demonstrator model. The demonstrator reward function may be expressed as the sum of respective terms generated by the demonstrator model for each time step of the plurality of demonstrator trajectories, averaged, e.g. in the logarithmic domain, over the plurality of demonstrator trajectories. Optionally in each iteration a different set of trajectories can be chosen (e.g. at random) to evaluate the demonstrator reward function.

Training the imitator model can be performed using imitation trajectories generated using the policy model (either the policy model in its current state, or in a recent state).

The term “jointly training” is used here to mean that the training process of the policy model and the imitator model is an iterative process in which updates to the policy model are interleaved with, or performed in parallel to, updates of the imitator model. As the policy model is trained (e.g. during intervals between updates to the policy model), it is used to generate new imitation trajectories, by using it to control the agent during corresponding periods, and recording the sets of state data at time steps during those periods. The policy model controls the agent by receiving the sets of state data, and from each set of state data generating respective action data which is transmitted as control data to the agent to cause the agent to perform an action.

As part of the updates to the policy model, the reward function is evaluated by comparing the demonstrator model and the imitator model. This may be done by evaluating, for a plurality of the imitation trajectories, the similarity of those imitation trajectories occurring according to (i.e. as evaluated using) the demonstrator model, and according to (i.e. as evaluated using) the imitator model. Conveniently, only some of the imitation trajectories available to the training system (i.e. a proper sub-set of a database of imitation trajectories stored in a replay buffer) may be used for this evaluation. Optionally, the update to the policy model may be performed using a maximum a posteriori policy optimization (MPO) algorithm.

Specifically, the reward function may be found as an average over the plurality of the imitation trajectories of a value representative of the difference between (i) the sum (or product) of the terms generated by the demonstrator model for each of the set of trajectories, and (ii) the sum (or product) of the terms generated by the imitator model for each of the set of trajectories. The reward function is higher when the difference is smaller.

The updates to the imitator model may be so as to increase the value of an imitator reward function which characterizes the probability of a plurality of the imitation trajectories occurring according to the imitator model (e.g. a subset of all the imitation trajectories). This imitator reward function may be expressed as the sum (or product) of the terms generated by the imitator model for each time step of the plurality of imitation trajectories, averaged, e.g. in the logarithmic domain, over the plurality of imitation trajectories. Optionally a different plurality of imitation trajectories could be chosen to evaluate the imitator reward function from the plurality of imitation trajectories used to obtain the reward function for training the policy model, but conveniently the same batch of imitation trajectories may be used for both.

As noted above, the updates to the policy model and the imitator model may be performed using “some” of the previously generated imitation trajectories. Specifically, for each update step, the updates to both the policy model and the imitator model may be performed using imitation trajectories selected (e.g. at random) for that update step from a “replay buffer”. The replay buffer is a database of the imitation trajectories generated during using the policy model in its current state and typically also in one or more of its previous states. Optionally, imitation trajectories may be deleted from the replay buffer (since as the policy model is trained older imitation trajectories are increasingly less representative of imitation trajectories which would be generated using the current policy model). For example, an imitation trajectory may be deleted from the replay buffer after a certain number of update steps have passed since it was generated.

The training of the policy model may be performed as part of a process which includes, for a certain task:
performing the task (e.g., under control of a demonstrator such as a human expert) a plurality of times and collecting the demonstrator trajectories characterizing the performances;
initializing a policy model; and
training the policy model by the technique described above.

The estimated value of the reward function may be used as, or more generally used to derive, a measure of the success of the training. Some conventional reinforcement learning situations use as their success measure a comparison of the actions generated by a trained policy model with a ground truth which is either the actions generated by the demonstrator during the demonstrator trajectories or is in fact an demonstrator policy (i.e. the policy used by the demonstrator to choose the actions which produced the demonstrator trajectories). By comparison, imitation learning may be seen as “inverse reinforcement learning” in which an unobserved reward function is recovered from the expert behavior. As noted, in examples of the present disclosure the actions generated by the demonstrator and the demonstrator policy are unavailable, or at least not used during the training procedure. The measure of success based on the reward value may be used for example to define a termination criterion for the training of the policy model, e.g. based on a determination that the measure of success is above a threshold and/or that the measure of success has increased by less than a threshold amount during a certain number X of immediately preceding iterations of the training procedure (measure of success has increased by less than the threshold amount during the last X iterations). Alternatively or additionally, the measure of success may be based on the ability of the ability of the imitator model to predict the imitation trajectories (and/or the demonstrator trajectories), and the termination criterion might comprise a determination that the predicted probability of the imitation trajectories (and/or demonstrator trajectories) under the imitator model has increased by less than a threshold amount during a predetermined number of the last training iterations.

Following the training of the policy network the policy network may be used to generate action data to control the agent (e.g., a real-world agent) to perform the task in an environment, e.g., based on state data (observations) collected by at least one sensor, such as a (still or video) camera for collecting image data.

The demonstrator model, policy model and imitator model are each adaptive systems which may take the form of a respective neural network. One or more of the neural networks (or all of them) may comprise a convolutional neural network which includes a convolutional layer which receives the state data (e.g. in the form of image data as discussed below) and from it generates convolved data. In a further possibility, one or more of the neural networks (particularly the policy model) may be a recurrent neural network which generates a corresponding output for each set of state data it receives. A recurrent neural network is a neural network that receives can use some or all of the internal state of the network from a previous time step in computing an output at a current time step based on an input for the current time step.

The subject matter described in this specification can be implemented in particular embodiments so as to realize one or more of the following advantages.

A policy model for controlling an agent to perform in an environment can be produced from instances of the task being performed by a demonstrator, even when no action data is available from those instances (e.g. when the demonstrator is a human, or is an agent which has a different control system from the one to be controlled by the policy model and is controlled by a different sort of action data). Accordingly, the present method is applicable to imitation learning tasks which cannot be performed using many conventional systems which rely on action data from instances of the task being performed by a demonstrator.

Furthermore, many previous approaches to imitation learning use an adversarial approach in which, for example, a discriminator attempts to distinguish between demonstrator trajectories and imitation trajectories, and the policy model is trained using a reward which depends upon how well the discriminator does this. This adversarial approach has the disadvantage that it often fails, because the discriminator learns to distinguish demonstrator trajectories from imitation trajectories based on factors which are irrelevant to the task, so that the reward is hardly correlated with how well the policy model performs the task. For example, if the lighting conditions which were used to produce the demonstrator trajectories are different from those used in the imitation trajectories, the discriminator may use that factor to distinguish the demonstrator trajectories from the imitation trajectories, so that the reward is unrelated to the task. The presently proposed method does not require a discriminator, so this problem does not arise. Instead, even if the state data contains irrelevant information, the training of the demonstrator model tends to generate a demonstrator model in which that portion of the state data is ignored because it is not of predictive value. This in turn means that the imitator model and policy model tend to ignore it. Experimentally, it has been found that examples of the present method strongly outperform known methods when there are distractor features in the state data.

### BRIEF DESCRIPTION OF THE DRAWING

The details of one or more embodiments of the subject matter of this specification are set forth in the accompanying drawings and the description below. Other features, aspects, and advantages of the subject matter will become apparent from the description, the drawings, and the claims.

FIG. 1 shows schematically how an expert interacts with an environment to perform a task.

FIG. 2 shows a system proposed by the present disclosure which controls an agent to perform actions in the environment.

FIG. 3 explains the operation of the training engine of the system of FIG. 2.

FIG. 4 is a flow diagram of a method proposed by the present disclosure for training a policy model proposed by the present disclosure.

FIG. 5 is composed of FIGS. 5A and 5B which compare, for two respective tasks, the quality of imitation trajectories produced by an example system according to the present disclosure and two other imitation learning algorithms.

Like reference numbers and designations in the various drawings indicate like elements.

### DETAILED DESCRIPTION

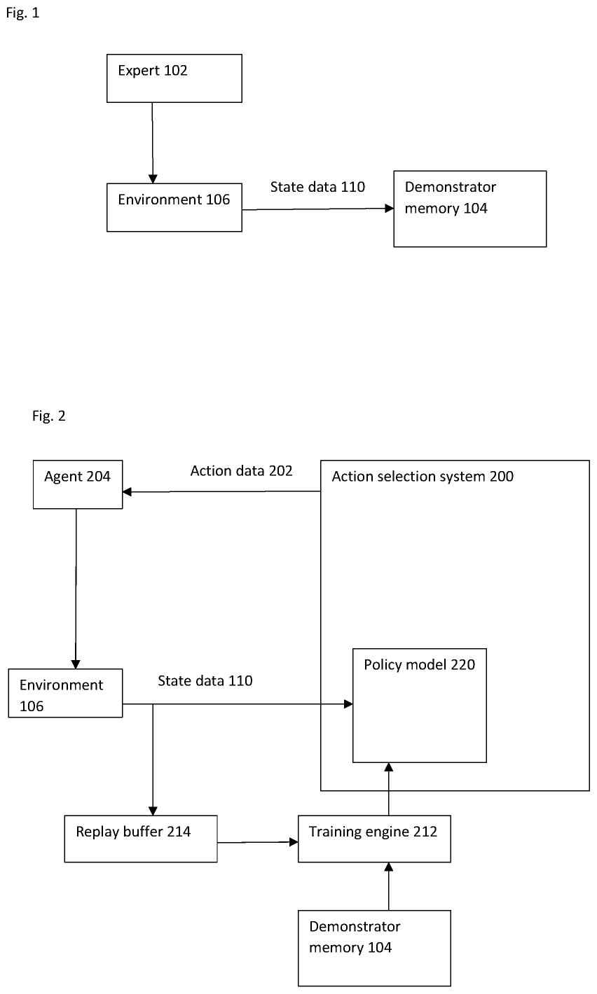

FIG. 1 shows schematically how an expert 102 (e.g. a human expert or a robot) interacts with an environment 106 to accomplish a goal (also referred to as “performing a task”). The expert 102 does this during a period (called an “episode”) which includes a number of times (“time steps”) T labelled by an integer index t=0, . . . , T−1. At each of these times t, respective state data denoted xₜ is collected from the environment 106 by making an observation of the environment 106. The beginning of the period is the time step t=0, and the state data of an initial state of the environment is denoted x₀. The collection of state data {xₜ} is referred to as a “demonstrator trajectory”. A change in the state data from one time step to the next within a trajectory (e.g. from xₜ₋₁ at time step t−1, to xₜ at the next time step t) is referred to as a “transition”. The demonstrator trajectory is stored in a demonstrator memory 104. Note that this notation, and the use of the terms “state” and “observation”, is not intended to imply that the environment 106 is a Markovian system. It need not be. Furthermore, the state data need not be a complete description of the state of the environment: it may only describe certain features of the environment and it may be subject to noise or other spurious signals (i.e. signals which are not informative about performing the task).

Optionally, in order to choose an action to take at a time step t, the expert 102 may receive the state data for the time step xₜ. However, alternatively or additionally, the expert have another source of information about the environment. For example, if the environment is a real world environment, a human expert 102 may be able to see the environment, and act continuously on the environment during the period. The state data {xₜ} is the output of one or more sensors (e.g. one or more cameras) which sense the real world environment at each of the time-steps, and the human expert may, or may not, be given access to the state data {xₜ}. If the expert is a human, he or she may perform the action himself/herself (e.g. with his/her own hands). Alternatively, the expert (whether human or non-human) may perform the action by generating control data for an agent (a tool) to implement to perform the action, but the control data may not be stored in the demonstrator memory 104.

Typically, the expert 102 will perform a certain task multiple more than once, i.e. there are multiple episodes. During each performance of the task (episode), a respective demonstrator trajectory is stored in the demonstrator memory 104. In a variation, multiple experts may attempt the task successively, each generating one or more corresponding demonstrator trajectories, each being composed of state data for one performance of the task for the corresponding expert. Note that the number of time steps T may be different for different ones of the demonstrator trajectories. All the demonstrator trajectories are stored in the demonstrator memory 104.

Each of the demonstrator trajectories stored in the demonstrator memory 104 may be denoted by {x_{t,j}^{D}}, where the D indicates that the demonstrator trajectory is generated by the expert 102, and the integer label j labels the demonstrator trajectory. Thus, at time t, during the j-th demonstrator trajectory, the measured state data obtained from the environment 106 was x_{t,j}^{D}.

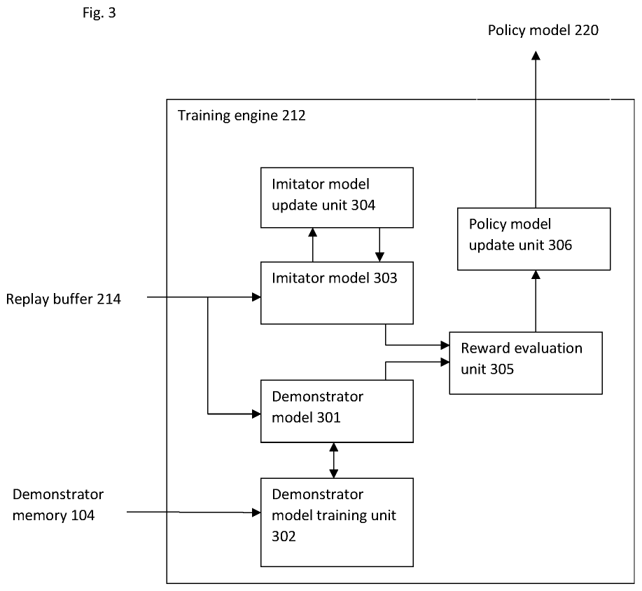

FIG. 2 shows an example action selection system 200 proposed by the present disclosure that is trained to control an agent 204 interacting with the environment 106 to perform the same task. The action selection system 200 is an example of a system implemented as computer programs on one or more computers in one or more locations in which the systems, components, and techniques described below are implemented.

The system 200 selects actions 202 to be performed by the agent 204 interacting with the environment 106 at each of multiple time steps to accomplish the task. This set of time steps is also referred to as an episode. At each time step t, the system 200 receives state data 110 (denoted xₜ) characterizing the current state of the environment 106 and selects an action (aₜ) to be performed by the agent 204 in response to the received state data 110. It transmits action data 202 specifying the selected action to the agent 204. At each time step, the state of the environment 106 at the time step (as characterized by the state data 110) depends on the state of the environment 106 at the previous time step and the action 102 performed by the agent 104 at the previous time step.

Some examples of the environments to which the disclosed methods can be applied follow.

In some implementations the environment 106 is a simulated environment and the agent is implemented as one or more computers interacting with the simulated environment. For example the simulated environment may be a simulation of a robot or vehicle and the imitation learning system may be trained on the simulation. For example, the simulated environment may be a motion simulation environment, e.g., a driving simulation or a flight simulation, and the agent is a simulated vehicle navigating through the motion simulation. In these implementations, the actions may be control inputs to control the simulated user or simulated vehicle. A simulated environment can be useful for training an imitation learning system before using the system in the real world. In another example, the simulated environment may be a video game and the agent may be a simulated user playing the video game. Generally in the case of a simulated environment the observations may include simulated versions of one or more of the previously described observations or types of observations and the actions may include simulated versions of one or more of the previously described actions or types of actions.

In a further example the simulated environment may be a protein folding environment such that each state is a respective state of a protein chain and the agent is a computer system for determining how to fold the protein chain. In this example, the actions are possible folding actions for folding the protein chain and the result to be achieved may include, e.g., folding the protein so that the protein is stable and so that it achieves a particular biological function. As another example, the agent 204 may be a simulated mechanical agent that performs or controls the protein folding actions selected by the system automatically without human interaction. The state data may include direct or indirect observations of a state of the protein and/or may be derived from simulation.

In a similar way the environment may be a drug design environment such that each state is a respective state of a potential pharma chemical drug and the agent is a computer system for determining elements of the pharma chemical drug and/or a synthetic pathway for the pharma chemical drug. The drug/synthesis may be designed based on a reward derived from a target for the drug, for example in simulation. As another example, the agent may be a mechanical agent that performs or controls synthesis of the drug.

In some implementations, as noted above, the environment is a real-world environment. The agent may be an electromechanical agent interacting with the real-world environment. For example, the agent may be a robot or other static or moving machine interacting with the environment to accomplish a specific task, e.g., to locate an object of interest in the environment or to move an object of interest to a specified location in the environment or to navigate to a specified destination in the environment; or the agent may be an autonomous or semi-autonomous land or air or sea vehicle navigating through the environment.

In these implementations, the observations may include, for example, one or more of images, object position data, and sensor data to capture observations as the agent interacts with the environment, for example sensor data from an image, distance, or position sensor or from an actuator. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. For example in the case of a robot the observations may include data characterizing the current state of the robot, e.g., one or more of: joint position, joint velocity, joint force, torque or acceleration, and global or relative pose of a part of the robot such as an arm and/or of an item held by the robot. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control inputs to control the robot, e.g., torques for the joints of the robot or higher-level control commands; or to control the autonomous or semi-autonomous land or air or sea vehicle, e.g., torques to the control surface or other control elements of the vehicle or higher-level control commands; or, e.g., motor control data. In other words, the actions can include for example, position, velocity, or force/torque/acceleration data for one or more joints of a robot or parts of another mechanical agent. Action data may include data for these actions and/or electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation, e.g., steering, and movement, e.g., braking and/or acceleration of the vehicle.

Alternatively, the agent 204 may be an electronic agent which controls a real-world environment 206 which is a plant or service facility, and the state data 110 may include data from one or more sensors monitoring part of the plant or service facility, such as current, voltage, power, temperature and other sensors and/or electronic signals representing the functioning of electronic and/or mechanical items of equipment. Thus, the agent may control actions in the environment 206 including items of equipment, for example in a facility such as: a data center, server farm, or grid mains power or water distribution system, or in a manufacturing plant or service facility. The observations may then relate to operation of the plant or facility. For example additionally or alternatively to those described previously they may include observations of power or water usage by equipment, or observations of power generation or distribution control, or observations of usage of a resource or of waste production. The agent may control actions in the environment to increase efficiency, for example by reducing resource usage, and/or reduce the environmental impact of operations in the environment, for example by reducing waste. For example the agent may control electrical or other power consumption, or water use, in the facility and/or a temperature of the facility and/or items within the facility. The actions may include actions controlling or imposing operating conditions on items of equipment of the plant/facility, and/or actions that result in changes to settings in the operation of the plant/facility, e.g., to adjust or turn on/off components of the plant/facility.

In some further applications, the environment is a real-world environment and the agent manages distribution of tasks across computing resources, e.g., on a mobile device and/or in a data center. In these implementations, the actions may include assigning tasks to particular computing resources. As further example, the actions may include presenting advertisements, the observations may include advertisement impressions or a click-through count or rate, and the reward may characterize previous selections of items or content taken by one or more users.

Referring again to FIG. 1, the action selection system 200 selects actions for the agent 204 to take using a policy model 220. The policy model 220 is denoted π_{θ}^{I}(xₜ|xₜ₋₁), where θ denotes a set of parameters defining the policy model. The parameters θ are iteratively trained by a training process described below. Once that training process terminates, the trained policy model 220 may be used to control the agent 204 to perform the task with no further training of the policy model 220.

The policy model 220, upon receiving state data xₜ at time step t, outputs corresponding output data indicative of the action, denoted aₜ, which the agent 204 should take in this time step. The action selection system 200 generates the action data 202 based on the output data from the policy model 220, and transmits it to the agent 204 to command it to perform a selected action.

In one case, the policy model 220 may generate the action data 202 itself, e.g. as a “one hot” vector which has respective components for each of the actions the agent 204 might perform, and in which one of the components takes a first value (e.g. 1) and all other components take a second different value (e.g. 0), such that the vector specifies the action corresponding to the component which takes the first value. More generally, the output data of the policy model 220 may be values for each of a set of possible actions which the agent 204 might take, and the action selection system 200 may select the action to be specified by the action data 202 as the action for which the corresponding value is highest. Alternatively, the output data may define a probability distribution over a set of possible actions, and the action selection system 200 may select the action from the set of possible actions as a random selection of one of the possible actions according to the probability distribution.

The policy model 220 is trained (that is, the parameters θ are iteratively set) using a training engine 212. The training engine 212 also receives the state data 110 at each time step, and stores this data in a replay buffer 214. The structure of the training engine 212 is explained below with reference to FIG. 3.

The sets of state data which is generated while the agent 204 is controlled by the action selection system 200 to perform the task are referred to as an “imitation trajectory”. The imitation trajectory {xₜ}, is stored in the replay buffer 214.

Typically, a plurality of imitation trajectories {xₜ} are generated in this way, representing different respective attempts to perform the task by the agent 204 under the control of the action selection system 110, and these imitation trajectories are stored in the replay buffer 214. Each imitation trajectory is denoted by {x_{t,k}^{I}}, where the I indicates that the imitation trajectory is generated by agent 204 under the control of the action selection system 110, and the integer label k labels each of the imitation trajectories. Thus, at time t, during the k-th imitation trajectory, the measured state data obtained from the environment 106 was x_{t,k}^{I}.

The training engine 212 trains the policy model 220 based on the demonstrator trajectories stored in the demonstrator memory 104, and the imitation trajectories stored in the replay buffer 214. Note that typically the demonstrator trajectories do not include action data (or if they do, it is not used for the training). Similarly, the imitation trajectories stored in the replay buffer 214 do not include any action data (or if they do, it is not used for the training). The fact that training engine 212 makes use of state data from the demonstrator trajectories and the imitation trajectories, but does not employ action data from either of these types of trajectory (and in particular not from the demonstrator trajectories), makes the present method suitable for a case in which action data generated by the expert 102 of FIG. 1 is not available (e.g. because the expert 102 used his or her hands to act on the environment during the generation of the demonstrator trajectories, rather than by issuing control instructions to equipment operating on the environment) or is not suitable for controlling the agent 204 (e.g. because agent 204 is different from a tool controlled by the expert 102).

The operation of the training engine 112 is now explained. Denoting a possible trajectory as X, the (unknown) distribution of the demonstrator trajectories by p^{D}(X), and the distribution of the imitation trajectories produced by a policy model 220 defined by parameters θ by p_{θ}^{I}(X), the parameters θ may be chosen such that the a measure of the divergence between these two probability distributions is low. For example, using the Kullback-Leibler (KL) divergence measure (choosing the case of reverse KL-divergence), minimizing the divergence corresponds to maximizing the expectation value over X of:

ρ_{form}=log p^{D}(X)−log p_{θ}^{I}(X) (1)

The training engine 112 is designed to treat ρ_{form} as a return, and maximize it using imitation learning techniques proposed by the present disclosure.

Each term of ρ_{form} is a log-density over the states encountered in an episode. Due to the chain rule for probability, log p^{D}(X) can be rewritten as log p(x₀)+Σ_{t>0} log p(xₜ|xₜ₋₁). As the initial state is independent of the policy, the reward term is equivalent to Σ_{t>0} log p(xₜ|xₜ₋₁). This means the return can be expressed solely in terms of next-step conditional densities (probabilities). To simplify the discussion, the explanation below is given in terms of one-step predictive models (i.e. based on probabilities such as log p(xₜ|xₜ₋₁)), but other examples of the operation of the training engine 212 may be used which do not use one-step predictive models.

FIG. 3 shows the structure of the training engine 212. To allow the calculation of the expectation value for X included in Eqn. (1), the training engine 212 includes two models referred to as “effect models”. The term “effect model” is used to mean a model of the probability distribution, given the state data xₜ₋₁ at time t−1, of the state data at time t being xₜ. Thus, the effect model is conditioned (only) on xₜ and xₜ₋₁. It is not conditioned on actions. It attempts to capture effects of policy and environment dynamics.

The first effect model is a demonstrator model 301. The demonstrator model 301 is defined by parameters ω and denoted p_{ω}^{D}(xₜ|xₜ₋₁). Upon receiving the inputs xₜ and xₜ₋₁, it outputs an estimate of p^{D}(xₜ|xₜ₋₁). If individual ones of the demonstrator trajectories are labelled by respective values of an integer index j, a given demonstrator trajectory may be denoted {x_{t,j}^{D}}. Thus, the demonstrator model 301 is operative to generate, for the j-th said demonstrator trajectory, a value indicative of the conditional probability of the demonstrator trajectory occurring given the initial state data x₀ at the start of the trajectory, i.e. as Π_{t>0}p_{ω}^{D}({x_{t,j}^{D}}|{x_{t-1,j}^{D}}).

The second effect model is an imitator model 303. The demonstrator model 303 is defined by parameters ϕ and denoted p_{ϕ}^{I}(xₜ|xₜ₋₁). Upon receiving the inputs xₜ and xₜ₋₁, it outputs an estimate of p^{I}_{θ}(xₜ|xₜ₋₁). If individual ones of the imitation trajectories are labelled by respective values of an integer index k, a given imitation trajectory may be denoted {x_{t,k}^{I}}. Thus, the imitator model 303 is operative to generate, for the k-th said imitation trajectory, a value indicative of the probability of the k-th imitation trajectory occurring, given the initial state data x₀ at the start of the trajectory and the policy model defined by the parameters θ, i.e. as Π_{t>0}p^{I}_{ϕ}(x_{t,k}^{I}|x_{t-1,k}^{I}).

The demonstrator model 301, the imitator model 303 and/or the policy model 220 may be implemented using neural networks such as feedforward networks, e.g. multi-layer perceptrons (MLP). For example, they may be implemented as 3 layer MLPs with tanh and exponential linear unit (ELU) nonlinearities. One or more of the models may however be implemented using a different type of neural network. For example, the policy network 220 might be implemented as a recurrent network. Furthermore, particularly in the case that the sensor data is in the form of a data array (e.g. a pixelated image), one or more of the demonstrator model 301, the imitator model 303 and/or the policy model 220 may include at the input one or more stacked layers which are convolutional layers. The demonstrator model 301 and imitator model 303 may each include a unit for multiplying the conditional probabilities for the transitions of a trajectory (or equivalently adding the logarithms of those conditional probabilities) to derive a value which indicates the probability of the entire trajectory occurring.

The training engine 212 includes a demonstrator model training unit 302, which iteratively modifies the parameters ω to find the parameters ω which solve:

$${max}_{ω} {𝔼}_{D} [ {\sum }_{t > 0} log {p}_{ω}^{D} ( {x}_{t} \vert {x}_{t - 1} ) ] \qquad ( 2 )$$

where [symbol] _{D} denotes the expectation value over p^{D}(X). The sum is over the T−1 times of the trajectory after the initial time t=0. The demonstrator model training unit solves Eqn. (2) by performing multiple iterations. The maximization process may be considered as maximizing a demonstrator reward function. In each iteration, the demonstrator training unit 302 randomly selects a batch of multiple demonstrator trajectories from the demonstrator memory 104, and performs a gradient step (e.g. using the Adam optimizer) in which the parameters ω are modified using the sum of Σ_{t>0} log p_{ω}^{D}(x_{t,j}^{D}|x_{t-1,j}^{D}) averaged over the batch of demonstrator trajectories (i.e. the respective j values for each of the batch of demonstrator trajectories), as a cost function to be maximized. This approximates Eqn. (2).

Using the trained demonstrator model 301, the training engine 212 jointly trains the policy model 220 and the imitator model 303 in an iterative process in which the iterated update steps to the policy model 220 and the imitator model 303 are interleaved or performed in parallel. This joint training process can follow the training of the demonstrator model 301, since the cost function of Eqn. (2) is not dependent on the imitator model 303, the policy model 220 or the imitation trajectories.

The joint training process is performed concurrently with multiple episodes in which the policy model 220 controls the agent 204 to perform the task in the environment 106, thereby generating multiple respective imitation trajectories which are added to the replay buffer 214. For example, in intervals between updates to the policy model 220 (and optionally to the imitator model 303), one or more episodes may be carried out of the action selection system 200 controlling the agent 204 using the policy model 220 to perform the task, resulting in one or more respective new imitation trajectories which are added to the replay buffer 214.

Optionally, imitation trajectories may be discarded from the replay buffer 214 according to a discard criterion (e.g. a given imitation trajectory may be discarded after a certain threshold number of updates have been made to the policy model 220 since the imitation trajectory was generated, or after a sum of the magnitudes of the updates to the policy model since the imitation trajectory was generated is above a threshold). The imitation trajectories are discarded because there is a risk that they are no longer statistically representative of imitation trajectories which the policy model 220 in its current state would produce.

Updates to the policy model 220 are made by a reward evaluation unit 305 and a policy model update unit 306. The reward evaluation unit 305 evaluates a reward function which is a measure of the similarity of the demonstrator model and the imitator model. Specifically, a batch of imitation trajectories is sampled from the replay buffer 214. The reward function is evaluated by determining, for the batch of imitation trajectories, a measure of the similarity of the probability of those imitation trajectories occurring according to the demonstrator model and according to the imitator model. This involves calculating, for the k-th imitation trajectory of the batch, and for each element of state data x_{t,k}^{I} for t above zero, a respective reward value:

rₜ=log p_{ω}^{D}(x_{t,k}^{I}|x_{t-1,k}^{I})−log p_{ϕ}^{I}(x_{t,k}^{I}|x_{t-1,k}^{I}). (3)

The policy model update unit 306 then updates the parameters θ of the policy model 220 to increase the sum of Eqn. (3) over all the values of t above 0, averaged over all the respective values of k for the batch of imitation trajectories. The Retrace algorithm may be used to do this. It amounts to training parameters θ of the policy model 220 to be the solution of:

$${max}_{θ} {𝔼}_{{π}_{θ}^{I} ( X )} [ {\sum }_{t > 0} log {p}_{ω}^{D} ( {x}_{t} \vert {x}_{t - 1} ) - log {p}_{ϕ}^{I} ( {x}_{t} \vert {x}_{t - 1} ) ] . \qquad ( 4 )$$

Despite the inclusion of two terms with opposite signs, the policy objective of Eqn. (4) is not an adversarial loss: it is based on a KL-minimization objective, rather than an adversarial minimax objective, and is not formulated as a zero-sum game. The second term in the objective can be viewed as an entropy-like expression.

Intuitively, the policy gradient does not involve gradients of either p_{θ}^{l} or p^{D} because neither of these densities are conditioned on the actions sampled from the policy (in effect, the contribution of the density to the policy gradient is integrated out).

Some known training algorithms (such as GAIL and its variants) are justified in terms of matching the state-action occupancy of a policy model to that of an expert. For example, GAIL attempts to unconditionally match the rates at which states and actions are visited. By contrast, the reward function of Eqn. (4) which is used to train the policy model 220 is derived directly from an objective that matches a policy model's effect on the environment in its initial state to that of the expert. This increases the stability of the learning, and makes it less subject to noise (e.g. in the state data).

The objective of Eqn. (4) includes both an expectation with respect to the current policy model 220 and a term that reflects the current imitator model 303. This might suggest that this objective is easiest to optimize in an on-policy setting. Nonetheless, it has been found that the algorithm explained above (i.e. a moderately off-policy setting, using the replay buffer 214), can optimize the objective stably. The Retrace algorithm corrects for mildly off-policy actions using importance sampling. The optimization of the policy model 220 may be performed using the MPO algorithm (Abdolmaleki et al., “Maximum a posteriori policy optimization”, In Proceedings of The International Conference on Learning Representation, 2018), since it is known to perform well in mildly off-policy settings. However, Eqn. (4) is not based on any MPO-specific assumptions, so it is expected to perform well with many other policy optimizers.

An imitator model update unit 304 then updates the parameters ϕ of the imitator model 303 (e.g. using the Adam algorithm) to increase the value of the sum, over all the values of t above 0 and over the all the respective values of k for the batch of imitation trajectories, of log p^{I}_{ϕ}(x_{t,k}^{I}|x_{t-1,k}^{I}). In other words, the imitator model update unit seeks the values of parameters ϕ which solve:

$${max}_{ϕ} {𝔼}_{I} [ {\sum }_{t > 0} log {p}_{ϕ}^{I} ( {x}_{t} \vert {x}_{t - 1} ) ] ,$$

where the expectation value [symbol] _{I} is obtained by summing over the transitions of the batch of imitation trajectories. The maximization process may be considered as maximizing an imitator reward function. Note that the updates to the imitator model 303 and the policy model 301 may be performed in the opposite order.

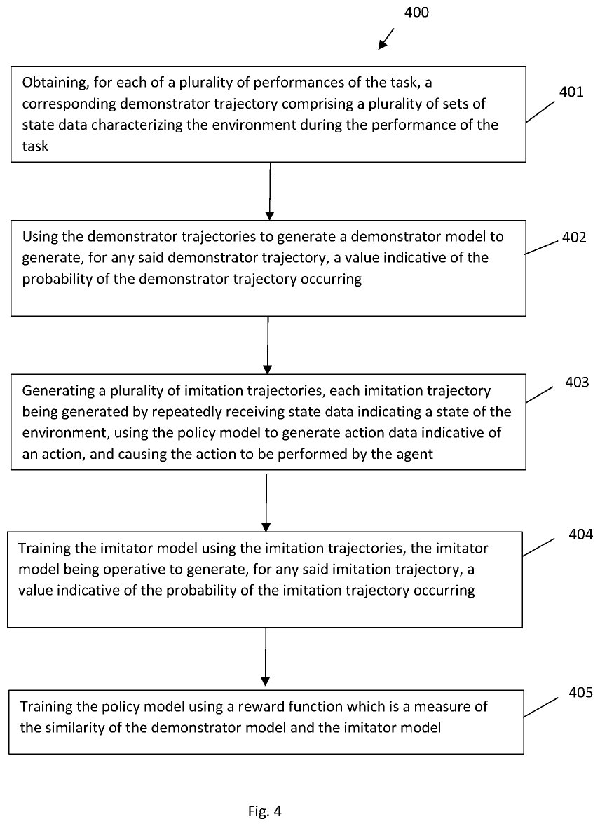

FIG. 4 summarizes a method 400 performed by the training engine 212. Method 400 is an example of a method which may be implemented as computer programs on one or more computers in one or more locations.

In step 401 of the method 400, a corresponding demonstrator trajectory is obtained for each of a plurality of performances of the task (episodes). As explained above with reference to FIG. 1, each demonstrator trajectory comprises a plurality of sets of state data characterizing the environment during the performance of the task. Note that while the process illustrated in FIG. 1 may be carried out to implement step 401, alternatively step 401 may be carried out by obtaining the demonstrator trajectories from a pre-existing database of demonstrator trajectories (e.g. a public database of videos showing a task being carried out).

In step 402, the demonstrator trajectories are used, as explained above with reference to FIG. 3, to generate the demonstrator model 301. As explained above, the demonstrator model 301 is operative to generate, for any said demonstrator trajectory, a value indicative of the probability of the demonstrator trajectory occurring.

In steps 403 to 405 the imitator model 303 and policy model 220 are trained jointly. The set of steps 403 to 405 is performed repeatedly as a series of iterations. In step 403, a plurality of imitation trajectories are generated. Each imitation trajectory is generated by, at each of T time steps t=0, . . . , T−1 receiving corresponding state data xₜ, indicating a state of the environment 106, using the policy model 220 to generate action data 202 indicative of an action, and causing the action to be performed by the agent 204.

In step 404, the imitator model 303 is trained using the imitation trajectories, such that the trained imitator model is operative to generate, for any said imitation trajectory, a value indicative of the probability of the imitation trajectory occurring. For example, the imitator model is operative to generate the conditional probabilities of each of the transitions of the imitation trajectory, and to multiply them together (or add their logarithms) to obtain the probability of the imitation trajectory occurring.

In step 405, the policy model 220 is trained using the reward function of Eqn. (4), which is a measure of the similarity of the demonstrator model and the imitator model. As described above, this similarity measure may be the average over a batch of imitation trajectories of the difference between probability values assigned by the demonstrator model and the imitator model to each of those imitation trajectories.

Experimental investigations were carried out comparing an example system according to the present disclosure (here referred to as FORM) with six other imitation learning algorithms on thirteen tasks from the DeepMind Control Suite (DCS) (Tassa, Y., Doron, Y., Muldal, A., Erez, T., Li, Y., de Las Casas, D., Budden, D., Abdolmaleki, A., Merel, J., Lefrancq, A., Lillicrap, T., and Riedmiller, M. DeepMind control suite. arXiv preprint arXiv:1801.00690, 2018.). The thirteen tasks used corresponding ones of six different domains (types of environment), and they did not include distractors. It was found that the asymptotic performance of FORM was better than most of these algorithms. For example, one such algorithm was as “Gail from Observations” (GAIfO) described in Torabi, F., Warnell, G., and Stone, P. Generative adversarial imitation from observation. In Imitation, Intent, and Interaction (I3) (ICML Workshop), 2019a, which is based on the GAIL algorithm. The GAIL algorithm struggles to imitate in the presence of a small number of differences between expert and imitator domains, and indeed the performance of FORM was better than GAIfO in most of the tasks. However, GAIfO can be improved using a regularized variant with a tuned gradient penalty (as suggested in Gulrajani, I., Ahmed, F., Arjovsky, M., Dumoulin, V., and Courville, A. C. Improved training of wasserstein GANs. In Proceedings of Neural Information Processing Systems (NeurIPS), 2017), and this will be referred to here as GAIfO-GP. The asymptotic performance of FORM was comparable to GAIfO-GP in the thirteen tasks considered, which, as noted, did not include distractors.

FORM, GAIfO and GAIfO-GP were studied for a number of the imitation learning tasks in the presence of added distractors, in the form of spurious signals added to the state data which are not informative about how to perform the task. For each domain, an expert was trained by reinforcement learning using a ground truth task reward. The experts were trained to convergence using MPO. 1000 demonstrator trajectories were produced using the expert, each depicting a respective episode having a duration of 1000 time steps (i.e. there were one million transitions in total).

Using the demonstrator trajectories, policy models having the same architecture were trained using FORM, GAIfO and GAIfO-GP. To model distractors, spurious signals were deliberately introduced into demonstrator trajectories before the training. These took the form of binary noise patterns drawn from a fixed set, and constant during the episode. Specifically, for each demonstrator trajectory (say the j-th trajectory), each item of state data x_{t,j}^{D} in the demonstrator trajectory is concatenated with an N-component binary vector bⱼ (where N is an integer) to form modified state data \tilde{x}_{t,j}^{D}=[x_{t,j}^{D}, bⱼ]. For each demonstrator trajectory, bⱼ is one of a set of M randomly generated N-component binary vectors, where M is an integer known as the “pool size”. {b₁, b₂, . . . , b_{M}}. Here the term “binary vector” is used to mean a vector in which each component is 0 or 1. Thus, each demonstrator trajectory was used to form a modified demonstrator trajectory, and the modified demonstrator trajectories were used in place of the original demonstrator trajectories for the imitation learning.

Similarly, a spurious signal is introduced into each imitation trajectory. Specifically, for each imitation trajectory (say the k-th trajectory), each item of state data x_{t,k}^{I} in the imitation trajectory is concatenated with an N-component random binary vector b.

Note that increasing N makes the task harder, by reducing the fraction of the state data which contains information useful to performing the task. Increasing M makes the task easier, because it means that each of the M spurious signals is present in a smaller proportion of the demonstrator trajectories. In other words, it has the effect of increasing the statistical similarity of the spurious signals as between the demonstrator trajectories and the imitation trajectories. A low value of M makes it easier to distinguish between the demonstrator trajectories and the imitation trajectories based on the spurious signals.

The spurious signals directly parallel situations encountered in practice involving under-sampled factors of variation. For example, when performing imitation learning using visual inputs with a robot, the background appearance of the rooms in which the expert data collection and imitation during deployment are performed correspond to two distinct distractor patterns that are intermingled with task-relevant portions of the state data. For imitation learning to work in such settings, the algorithm must be robust to changes in the background distractors. The sensitivity of the imitation learning algorithm to the presence of under-sampled factors of variation can be determined by observing how stable its performance is as the pool size M decreases.

FORM was implemented using simple feedforward architectures to parameterize the demonstrator model, imitator model and policy models. Each was implemented as a 3 layer MLP with 256 units, and tanh and ELU nonlinearities. The action data was a mixture of 4 Gaussian components with a diagonal covariance matrix, with the policy model outputting Gaussian mixture model (GMM) mixture coefficients and the means and standard deviations of each component. In all experiments, the standard deviation was clipped to a minimum value of 0.0001. The same architecture and same hyperparameters were used for the imitator model and the demonstrator model for each of the tasks and environments.

The demonstrator models for the various tasks and environments were trained offline for 2 million steps. The inputs to the demonstrator model and imitator model were standardized using per-dimension means and variances estimated by exponential moving averages. This made it harder for those to distinguish noise dimensions from ones carrying state information, but it was found that this improved generative model training (it did not affect GAIfO training).

Three forms of regularization were used with the demonstrator model and imitator models: (i) [symbol] ₂ weight-decay, (ii) training on data generated by agent rollouts, i.e. using the network output at a time step as the input at the next time step during training, (iii) and prediction of observations at multiple future time steps. In all experiments, the hyperparameter settings of all regularizers were shared between the demonstrator model and imitator model (rather than tuning them separately). For each domain, the [symbol] ₂ weight were tuned (using sweeping values of [0.0, 0.01, 0.1, and 1.0]), and the fraction of each batch generated by agent rollouts were also tuned (using sweeping values of [0.0, 0.01, 0.1, 1.0]), but otherwise identical hyperparameters were used for all FORM models.

For all imitation learning methods (FORM, GAIfO and GAIfO-GP), the underlying policy model was trained with MPO and experience replay. This entailed the use of a critic network. Both the policy model and critic network encoded a concatenation of the state data that has been passed through a tanh activation. Both encoded the state data with independent 3-layer MLPs using ELU activations. The policy model projected the state data to derive the mean and scale of a Gaussian action distribution. The critic concatenates the sampled action, applies a layernorm operation, and a tanh, and applies another 3-layer MLP to produce the Q-value. All hidden layers had a width of 256 units.

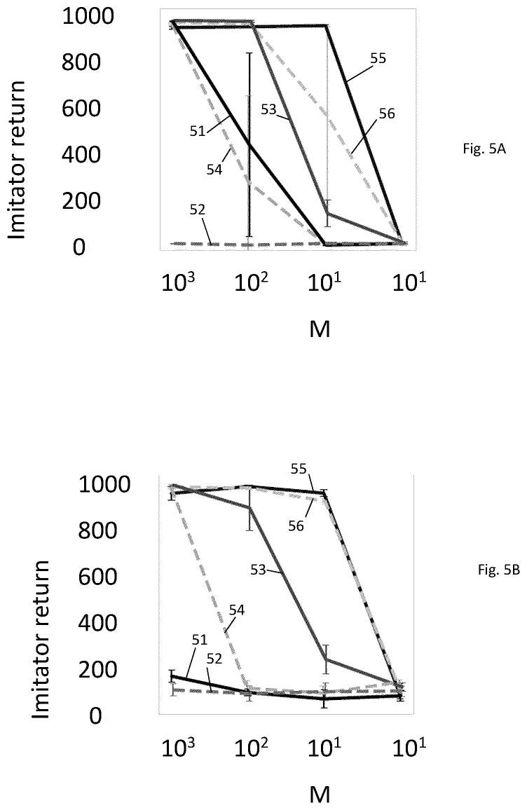

FIG. 5A compares the quality of imitation trajectories produced by the FORM method (i.e. the example system according to the present disclosure) with the imitation trajectories for GAIfO and GAIfO-GP, for a task in the DCS called “walker run”. A quality measure of the imitation trajectories is shown by the vertical axis (“imitator return”), while the horizontal axis represents M (the number of spurious signals in the demonstrator trajectories). The results for GAIfO for N=8 are shown by the line 51, and the results for GAIfO for N=16 are shown by the line 52. The results for GAIfO-GP for N=8 are shown by the line 53, and the results for GAIfO for N=16 are shown by the line 54. The results for FORM for N=8 are shown by the line 55, and the results for FORM for N=16 are shown by the line 56. Each line connects experimental results obtained for M=1000, M=100, M=10 and M=1, and error bars for each of these results are given, indicating the variation in performance for different instances of training. It will be seen that in the case of N=16, GAIfO performs poorly even for high M. GAIfO-GP performs better than GAIfO. For M=1000, GAIfO-GP and FORM perform approximately equally well for both N=8 and N=16, but the performance of GAIfO-GP for N=16 drops significantly in the case of M=100. The performance of GAIfO-GP in the cases of N=8 and N=16 is poor for M=10, whereas the performance of FORM remains fairly good for M=10 in the case of N=16, and very good in the case of N=8. This again shows how successful FORM is at ignoring distractors, compared to GAIfO-GP.

FIG. 5B shows results for a second task known as “quadruped walk” from the DCS. Again, the results for GAIfO for N=8 are shown by the line 51, and the results for GAIfO for N=16 are shown by the line 52. The results for GAIfO-GP for N=8 are shown by the line 53, and the results for GAIfO for N=16 are shown by the line 54. The results for FORM for N=8 are shown by the line 55, and the results for FORM for N=16 are shown by the line 56. Each line connects experimental results obtained for M=1000, M=100, M=10 and M=1, and error bars for each of these results are given, indicating the variation in performance for different instances of training. The results are generally similar to those of FIG. 5A, except that the performance of FORM is very good for M=10 in both of the cases N=8 and N=16. For both these cases both GAIfO and GAIfO-GP exhibit very poor performance. This again shows how successful FORM is at ignoring distractors, compared to GAIfO and GAIfO-GP.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A method of training a policy model to generate action data for controlling an agent to perform a task in an environment, the method comprising:
obtaining, for each of a plurality of performances of the task, a corresponding demonstrator trajectory comprising a plurality of sets of state data characterizing the environment at each of a plurality of corresponding successive time steps during the performance of the task;
using the demonstrator trajectories to generate a demonstrator model, the demonstrator model being operative to generate, for any said demonstrator trajectory, a value indicative of the probability of the demonstrator trajectory occurring; and
jointly training an imitator model and a policy model by:
generating a plurality of imitation trajectories, each imitation trajectory being generated by repeatedly receiving state data indicating a state of the environment, using the policy model to generate action data indicative of an action, and causing the action to be performed by the agent;
training the imitator model using the imitation trajectories, the imitator model being operative to generate, for any said imitation trajectory, a value indicative of the probability of the imitation trajectory occurring; and
training the policy model using a reward function which is a measure of the similarity of the demonstrator model and the imitator model.

2. The method of claim 1, wherein the reward function is evaluated by determining, for at least some of the imitation trajectories, a measure of the similarity of the probability of those imitation trajectories occurring according to the demonstrator model and according to the imitator model.

3. The method of claim 1, wherein the demonstrator model is trained to generate a value indicative of the probability of a set of state data of one of the demonstrator trajectories occurring based on the set of state data for at least one earlier time step in that demonstrator trajectory, the demonstrator model being operative to generate the value indicative of the probability of a corresponding one of the demonstrator trajectories occurring as the product of the respective probabilities of the sets of state data of the demonstrator trajectory.

4. The method of claim 1, wherein the imitator model is trained to generate a value indicative of the probability of a set of state data of one of the imitation trajectories occurring based on the set of state data for at least one earlier time step in that imitation trajectory, the imitator model being operative to generate the value indicative of the probability of a corresponding one of the imitation trajectories occurring as the product of the respective probabilities of the sets of state data of the imitation trajectory.

5. The method of claim 1, wherein said jointly training the second imitator model and the policy model is performed in plurality of update steps, each update step comprising:
generating one or more said imitation trajectories using the current policy model;
updating the policy model using the reward function using one or more of the imitation trajectories; and
updating the imitator model using one or more of the generated imitation trajectories.

6. The method of claim 5, wherein the imitator model is updated to increase the value of an imitator reward function which characterizes the probability of at least some of the generated imitation trajectories occurring according to the imitator model.

7. The method of claim 5, wherein the update to the policy model is performed using a maximum a posteriori policy optimization algorithm.

8. The method of claim 5, wherein generated imitation trajectories are added to a replay buffer, and said updating of the policy model and the imitator model are performed using imitation trajectories selected from the replay buffer.

9. The method of claim 1, wherein the demonstrator model is trained before the joint training of the imitator model and the policy model.

10. The method of claim 1, wherein the demonstrator model is trained by a process which iteratively increases the value of a demonstrator reward function which characterizes the probability of at least some of the demonstrator trajectories occurring according to the demonstrator model.

11. The method of claim 1, wherein the environment is a real-world environment, the state data is data collected by at least one sensor, and the agent is an electromechanical agent arranged to move in the environment according to the action data.

12. The method according to claim 1, wherein the state data comprises image data defining a plurality of images of the environment.

13. The method of claim 1, further comprising performing a task by using the policy model to generate commands for controlling an agent to perform the task in an environment, comprising:
at each of a plurality of time steps performing the steps of:
(i) obtaining state data characterizing a current state of the environment;
(ii) transmitting the state data to the policy model, the policy model generating action data based on the state data; and
(iii) transmitting the action data to the agent, the agent being operative to perform an action defined by the action data within the environment;
whereby the policy model successively generates a sequence of sets of action data to control the agent to perform the task.

14.-17. (canceled)

18. A system comprising:
one or more computers; and
one or more storage devices communicatively coupled to the one or more computers, wherein the one or more storage devices store instructions that, when executed by the one or more computers, cause the one or more computers to perform operations for training a policy model to generate action data for controlling an agent to perform a task in an environment, the operations comprising:
obtaining, for each of a plurality of performances of the task, a corresponding demonstrator trajectory comprising a plurality of sets of state data characterizing the environment at each of a plurality of corresponding successive time steps during the performance of the task;
using the demonstrator trajectories to generate a demonstrator model, the demonstrator model being operative to generate, for any said demonstrator trajectory, a value indicative of the probability of the demonstrator trajectory occurring; and
jointly training an imitator model and a policy model by:
generating a plurality of imitation trajectories, each imitation trajectory being generated by repeatedly receiving state data indicating a state of the environment, using the policy model to generate action data indicative of an action, and causing the action to be performed by the agent;
training the imitator model using the imitation trajectories, the imitator model being operative to generate, for any said imitation trajectory, a value indicative of the probability of the imitation trajectory occurring; and
training the policy model using a reward function which is a measure of the similarity of the demonstrator model and the imitator model.

19. One or more non-transitory computer storage media storing instructions that when executed by one or more computers cause the one or more computers to perform operations for training a policy model to generate action data for controlling an agent to perform a task in an environment, the operations comprising:
obtaining, for each of a plurality of performances of the task, a corresponding demonstrator trajectory comprising a plurality of sets of state data characterizing the environment at each of a plurality of corresponding successive time steps during the performance of the task;
using the demonstrator trajectories to generate a demonstrator model, the demonstrator model being operative to generate, for any said demonstrator trajectory, a value indicative of the probability of the demonstrator trajectory occurring; and
jointly training an imitator model and a policy model by:
generating a plurality of imitation trajectories, each imitation trajectory being generated by repeatedly receiving state data indicating a state of the environment, using the policy model to generate action data indicative of an action, and causing the action to be performed by the agent;
training the imitator model using the imitation trajectories, the imitator model being operative to generate, for any said imitation trajectory, a value indicative of the probability of the imitation trajectory occurring; and
training the policy model using a reward function which is a measure of the similarity of the demonstrator model and the imitator model.

20. The non-transitory computer storage media of claim 19, wherein the reward function is evaluated by determining, for at least some of the imitation trajectories, a measure of the similarity of the probability of those imitation trajectories occurring according to the demonstrator model and according to the imitator model.

21. The non-transitory computer storage media of claim 10, wherein the demonstrator model is trained to generate a value indicative of the probability of a set of state data of one of the demonstrator trajectories occurring based on the set of state data for at least one earlier time step in that demonstrator trajectory, the demonstrator model being operative to generate the value indicative of the probability of a corresponding one of the demonstrator trajectories occurring as the product of the respective probabilities of the sets of state data of the demonstrator trajectory.

22. The non-transitory computer storage media of claim 19, wherein the imitator model is trained to generate a value indicative of the probability of a set of state data of one of the imitation trajectories occurring based on the set of state data for at least one earlier time step in that imitation trajectory, the imitator model being operative to generate the value indicative of the probability of a corresponding one of the imitation trajectories occurring as the product of the respective probabilities of the sets of state data of the imitation trajectory.

23. The non-transitory computer storage media of claim 19, wherein said jointly training the second imitator model and the policy model is performed in plurality of update steps, each update step comprising:
generating one or more said imitation trajectories using the current policy model;
updating the policy model using the reward function using one or more of the imitation trajectories; and
updating the imitator model using one or more of the generated imitation trajectories.

24. The non-transitory computer storage media of claim 23, wherein the imitator model is updated to increase the value of an imitator reward function which characterizes the probability of at least some of the generated imitation trajectories occurring according to the imitator model.
